(19) United States
(12) Patent Application Publication
(10) Pub. No.: US 2026/0080110 A1
(43) Pub. Date: Mar. 19, 2026

(54) PHYSICAL FIELD DETERMINATION SYSTEM AND METHOD

(71) Applicant: Vinci4D.ai, Inc., Palo Alto, CA (US)

(72) Inventors: Sarah Osentoski, Palo Alto, CA (US); Hardik Kabaria, Palo Alto, CA (US)

(73) Assignee: Vinci4D.ai, Inc., Palo Alto, CA (US)

(21) Appl. No.: 19/332,821

(22) Filed: Sep. 18, 2025

Related U.S. Application Data
(60) Provisional application No. 63/696,231, filed on Sep. 18, 2024.

(51) Int. Cl. G06F 30/10; G06F 30/27; G06F 111/10; G06N 3/0455; G06N 3/084

(52) U.S. Cl. CPC G06F 30/10; G06F 30/27; G06N 3/0455; G06N 3/084; G06F 2111/10

(57) ABSTRACT

Variants of the method can include determining a design, generating a geometric representation of the design, generating a topological representation of the design, determining a context value set, predicting a physical field using a trained physics model, optionally verifying the physical field, optionally generating a corrected physical field, and optionally training the physics model based on the corrected physical field.

### CROSS-REFERENCE TO RELATED APPLICATIONS

This application claims the benefit of U.S. Provisional Application No. 63/696,231 filed 18 Sep. 2024, which is incorporated in its entirety by this reference.

### TECHNICAL FIELD

This invention relates generally to the physics simulation field, and more specifically to a new and useful physical field determination in the physics simulation field.

### BACKGROUND

Partial differential equations (PDEs) are widely used to model complex physical systems in various fields such as engineering, physics, and biology. These equations describe phenomena like heat transfer, fluid dynamics, structural mechanics, and/or other physical characteristics. Traditionally, PDEs have been solved using numerical methods such as finite element analysis (FEA). While effective, these numerical approaches can be computationally expensive and slow, especially for complex geometries or when many simulations are required.

In recent years, there has been growing interest in using machine learning techniques to accelerate physical field solving. Neural network-based approaches aim to learn mappings between input conditions and PDE solutions, potentially offering significant speedups compared to traditional numerical solvers. However, applying machine learning to PDE solving comes with several challenges.

One challenge is handling irregular, complex geometries that are common in real-world engineering problems. Many existing machine learning models are designed for regular grids, limiting their applicability to complex shapes. Additionally, conventional geometry models are built for computer vision and perception, which only consider the boundaries of any given design; physical field modeling requires consideration of the entire design domain (e.g., the material between the boundaries). Another difficulty is incorporating multiple types of input functions and boundary conditions in a flexible way. Additionally, physical systems often exhibit multiscale behavior, with phenomena occurring at different spatial scales that can be challenging to capture accurately.

There is an ongoing need for improved machine learning approaches that can handle the complexities of real-world PDE solving tasks while maintaining accuracy and computational efficiency. Advancements in this area could enable faster design iterations, optimization, and analysis across many engineering and scientific domains.

### BRIEF DESCRIPTION OF THE FIGURES

FIG. 1 is a schematic representation of a variant of the method.

FIG. 2 is a schematic representation of a variant of geometric embedding determination.

FIG. 3 is an illustrative example of a method of generating the geometric model.

FIG. 4 is a schematic representation of a variant of generating the physical field and training the physics model.

FIG. 5 is an illustrative example of a variant of the physics model.

FIG. 6 is a schematic representation of a variant of the method.

FIG. 7 is a schematic representation of a variant of the method.

FIG. 8 is a schematic representation of a variant determining a hybrid loss.

FIG. 9 is a schematic representation of a variant extracting geometric latents.

FIGS. 10A and 10B are illustrative examples of variants of a design.

### DETAILED DESCRIPTION OF THE INVENTION

The following description of the embodiments of the invention is not intended to limit the invention to these embodiments, but rather to enable any person skilled in the art to make and use this invention.

### 1. Overview

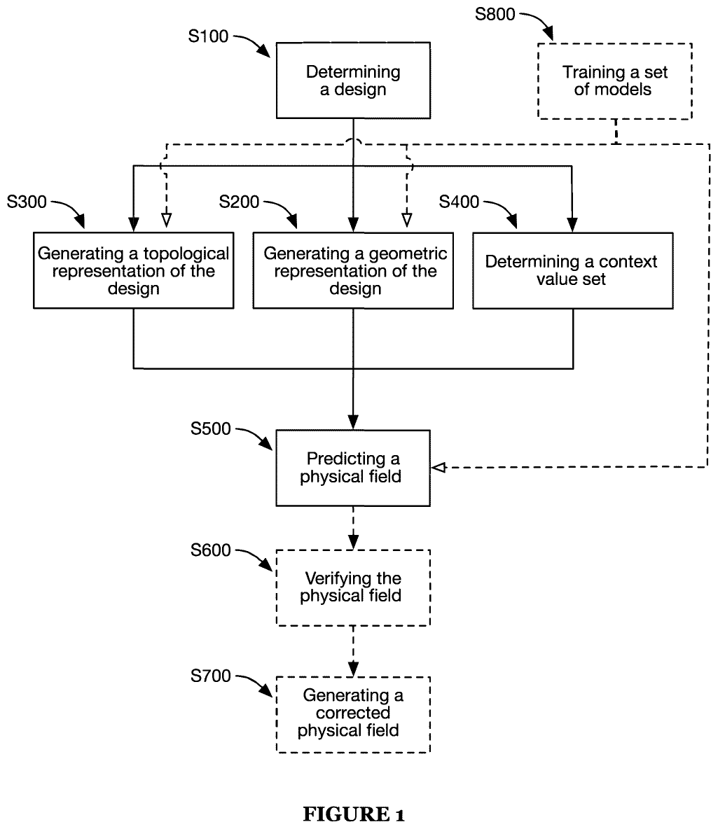

As shown in FIG. 1, the method can include determining a design S100, generating a geometric representation of the design S200, optionally generating a topological representation of the design S300, determining a context value set S400, predicting a physical field S500, optionally verifying the physical field S600, optionally generating a corrected physical field S700, and optionally training a set of models S800. The method functions to determine (e.g., infer, predict, compute, estimate, etc.) physicals fields for a design.

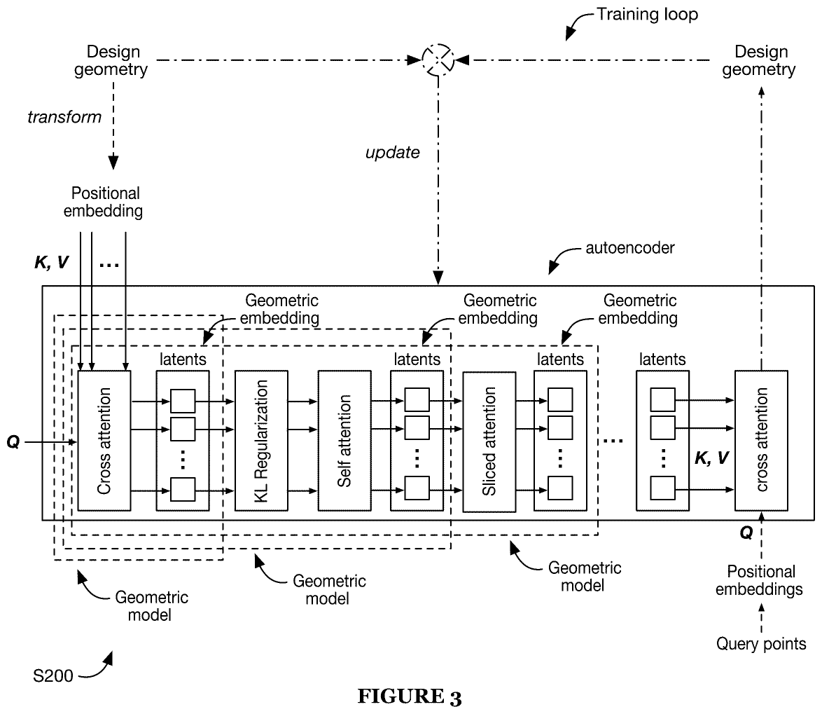

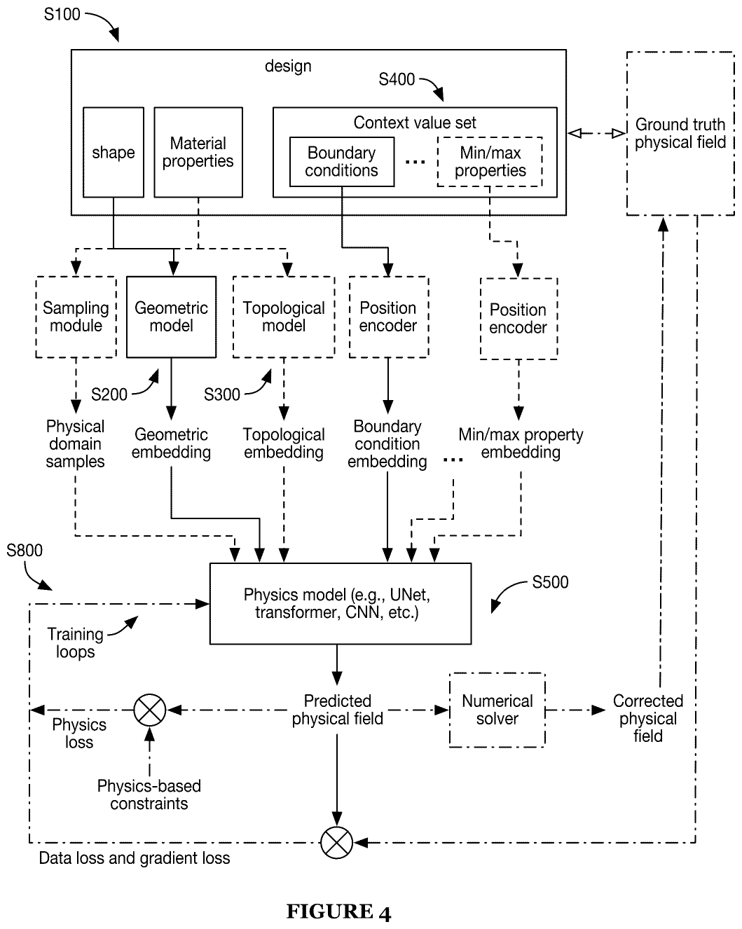

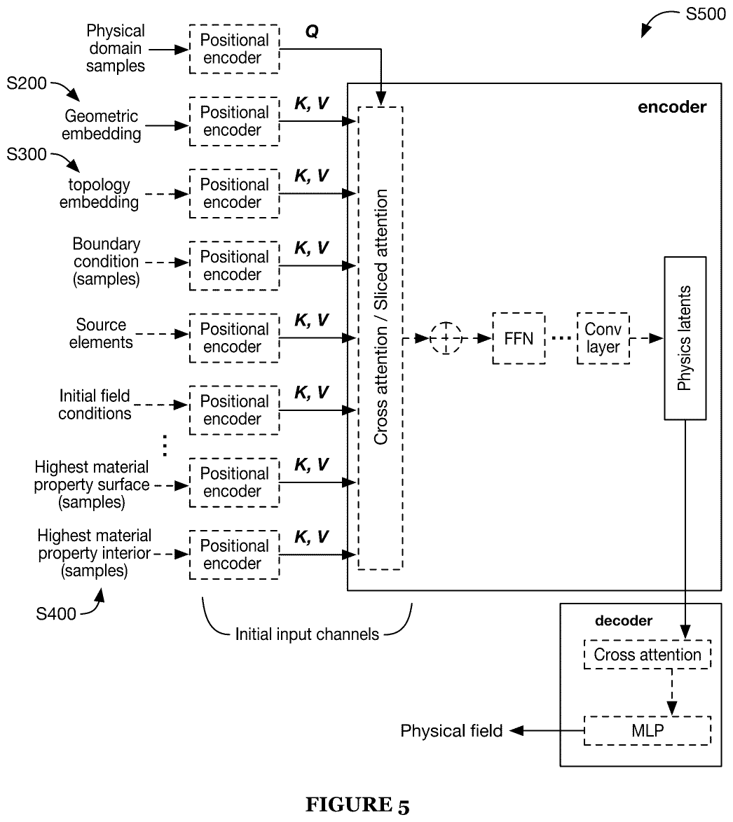

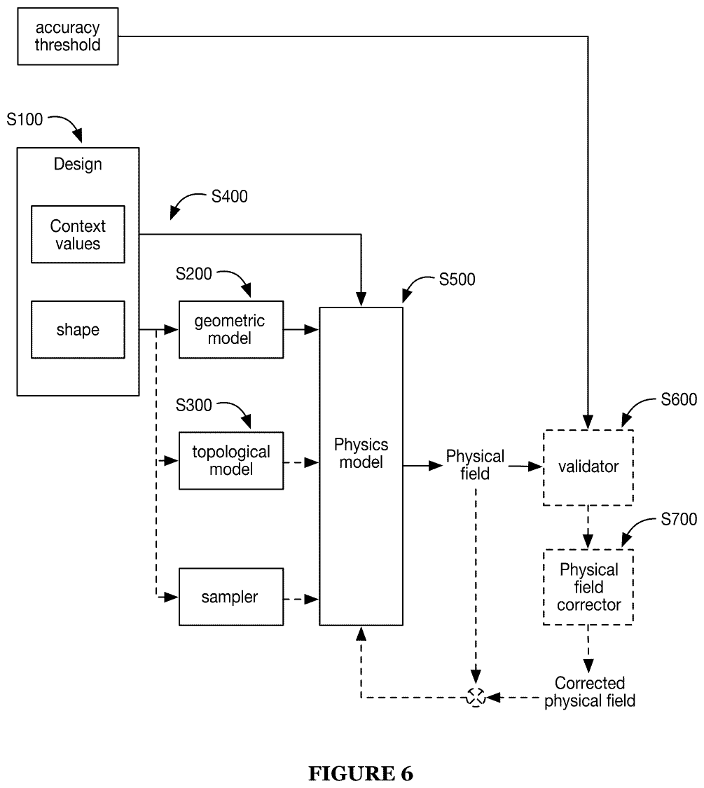

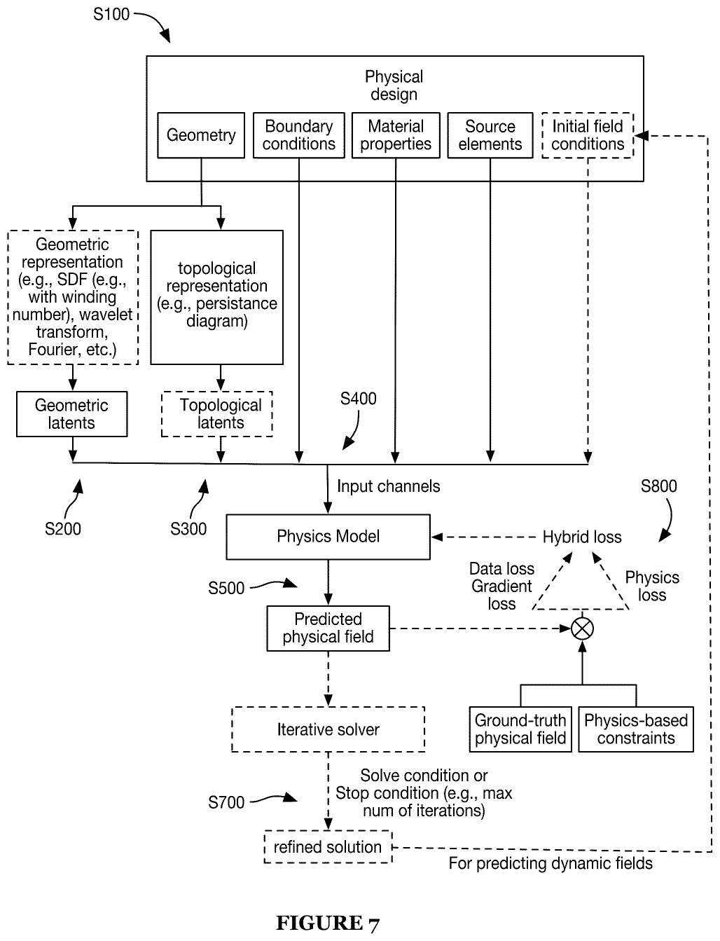

In an illustrative example, the method can include: determining a design from a user; generating a geometric embedding of the design using a geometric encoder; generating a topological representation (e.g., embedding) of the design; determining a context value set; inferring a physical field using the geometric embedding, the topological representation, and the context value set; optionally verifying the inferred physical field against a set of governing equations for the design or against a numerical solver (e.g., a set of partial differential equations for the physical characteristic of the physical field); optionally correcting the inferred physical field using a numerical solver (e.g., by seeding the numerical solver with the inferred physical field); and providing the resultant physical field to the user. The method can also optionally include training a set of models (e.g., geometric model, physics model, topological model, etc.). An example is shown in FIG. 6. In the illustrative example, the geometric encoder can be an encoder extracted from an autoencoder (e.g., a diffusion model) that was trained end-to-end to encode a geometry into a latent space, then decode the geometric encoding (geometric embedding) back into the geometry. An example is shown in FIG. 3. The geometric embedding can be determined by converting the design geometry to a secondary representation, generating position embeddings by projecting the secondary representation into a spatial domain (e.g., using a wavelet transform, wherein the wavelets represent localized oscillations in the geometry), and feeding the position embeddings into the geometric encoder. The topological representation can include a persistence diagram of the design. The context value set (e.g., physical parameters, etc.) can include: boundary conditions (and design positions thereof), parameters, material properties, source information, coefficients (e.g., thermal properties, mechanical properties, electrical properties, fluid properties, friction properties etc.), initial conditions (e.g., for determining dynamic fields, example shown in FIG. 7), samples (e.g., measurements under a predetermined set of conditions, at predetermined points, etc.), initial conditions (e.g., when the model is a dynamic model), and/or values for any other suitable physical parameters. The physical parameters are preferably explicit physical parameters (e.g., with physically interpretable, measurable quantities), but can alternatively be (or be transformed into) implicit physical parameters (e.g., hidden, abstract, or derived quantities that are not directly measurable or interpretable) In the illustrative example, the physical field can be inferred using a physics model specific to the physical characteristic (e.g., structural analyses, thermal analyses, fluid dynamics, electromagnetics, etc.), or a generalized physics model. The physics model can be or include a neural network (e.g., transformer, encoder, CNN, UNet, FFN, DNN, etc.) that receives a set of boundary condition values and geometric positions thereof, key physical characteristics (e.g., highest conductivity, lowest conductivity, etc.) and geometric positions thereof, the geometric embeddings, topological embeddings (e.g., determined using a persistence diagram of the design subelements, using graph clustering, etc.), and/or other data as inputs, generates a physics embedding (e.g., using a physics encoder), and infer the physical field (e.g., temperature field, pressure field, velocity field, etc.) for each of a set of geometric positions (e.g., physical domain samples) based on the physics embedding. Examples are shown in FIG. 4 and FIG. 5. The physics model can be trained against a physics loss (e.g., calculated using the PDEs for the respective physics characteristic), a data loss (e.g., calculated by comparing the inferred physics field to a ground-truth physics field that was measured or generated using a classical simulator, such as FEA, etc.), a gradient loss, a hybrid loss (e.g., weighted blend of the physics and data losses), and/or any other loss. Examples are shown in FIG. 4 and FIG. 5. In the illustrative example, in variants, the inferred physics field can be verified by a classical numerical solver (e.g., using PDEs for the respective physics characteristic, using FEA, etc.) to a predetermined accuracy (e.g., standard accuracy threshold, user-provided accuracy, etc.). The inferred physics field can be provided to the user when valid, and can be corrected, then provided to the user, when invalid. The inferred physics field can be corrected by seeding a classical numerical solver with the inferred physics field values, or otherwise corrected. An example is shown in FIG. 6. However, the physics field can be otherwise determined.

### 2. Technical Advantages

Variants of the technology can confer several benefits over conventional approaches.

First, variants of the technology can determine (e.g., infer, predict) physical fields faster than conventional numerical solvers by leveraging machine learning models. In examples, this can be accomplished by converting the design into a set of embeddings (e.g., geometric embeddings, topological embeddings, etc.), and inferring the physical field based on the set of embeddings. Because the embeddings (latents) are more compact than the original design, inferring the physical field based on the embeddings requires less computation and can be faster than numerical methods. In examples, the technology can also leverage boundary conditions and other context value sets as constraints to limit the search space for machine learning inference.

Second, variants of the technology can infer physical fields for a wide variety of complex designs and scales. In a first example, complex designs can be represented using signed distance functions, which can provide a continuous representation of the designs that captures fine details. This can also enable the entire design domain to be represented, instead of only the design boundaries. This can enable the design geometry to be flexibly sampled at different resolutions (e.g., different scales) to increase geometric representation fidelity, and/or sampled to meet a predetermined model input shape (e.g., predetermined geometric encoder input vector dimensions). In a second example, the design geometry can be encoded using a wavelet transform, which can enable the geometry to be represented in higher fidelity. In this example, the design geometry can be encoded in a spatial domain, a spatial-frequency domain, a time-frequency domain, and/or other domain. In a third example, representing the design as a set of latents (e.g., embeddings) and working in the latent space enables the technology to generalize to new geometries outside of the training data distribution.

Third, variants of the technology can provide accurate physical fields, even if the design is outside of the training data sets. In a first example, the physics model can be more accurate than conventional neural networks by training on a physics loss in addition to (and/or in lieu of) a data loss. The physics loss can be calculated using a numerical verifier or numerical solver, using the governing physics equations (e.g., PDEs) for the respective physical characteristic (e.g., for the physical system, etc.), or otherwise determined. In an example, the physics loss can be determined by computing whether the solution satisfies the governing equations for the respective physical problem. The data loss can be calculated by comparing a ground-truth physical field for the design to the determined physical field, or otherwise determined. This physics-informed approach allows the physics model to generalize better to new geometries with limited training data, compared to purely data-driven methods. In variants, the physics model can also be trained on gradient loss (e.g., H1 seminorm, total variation loss, L2 gradient loss, H2 seminorm, Laplacian loss, etc.), which can be used to enforce smoothness, continuity, and physical consistency. In a second example, the determined physical field can be verified by a verifier (e.g., physics-based simulator, a numerical solver, using the PDEs for the respective physical characteristic, etc.) to a predetermined accuracy range (e.g., user-accuracy threshold range) before providing the determined physical field to the user. In a third example, the determined physical field can be used as a seed solution to a numerical solver to calculate the final physical field, which can enable faster convergence compared to a conventional initialization. This combines the speed of machine learning inference with the reliability of physics-based simulation (when needed), which allows for fast approximate solutions in many cases, with the option to refine results for high-accuracy applications.

Fourth, variants of the technology can generate synthetic training data, which can be used to retrain the physics model. For example, physical fields can be inferred by the physics model for new designs (e.g., received from a user, scraped from a repository, generated by perturbing geometry embeddings and/or topology embeddings, generated using a diffusion model, etc.), verified using a verifier, and numerically solved if the inferred physical field is below a threshold accuracy. In variants, the numerical solver can be seeded with the inferred physical field to enable faster convergence. The physics model can then be retrained to infer the accurate (numerically solved) physical field. This allows the system to continuously improve and expand its capabilities in a self-reinforcing manner. The ability to rapidly generate diverse training data is particularly valuable for engineering applications where obtaining real-world data can be resource-consuming and expensive.

However, further advantages can be provided by the system and method disclosed herein.

### 3. System

In variants, the system includes: a physics model; an optional geometric model; an optional topological model; a physics encoder; and a physics decoder. The system functions to determine (e.g., predict, compute, estimate, etc.) physical fields using a physics model and/or any suitable models (e.g., geometric model, topological model, etc.).

The physics model functions to predict a physical field based on a design. The system can include one or more physics models. In variants where the system includes multiple physics models, the different physics models can predict physical fields for the same or different physical characteristics or domains, length scales, temporal scales (e.g., static, dynamic, fast-changing phenomena, slow-changing phenomena), and/or any other prediction characteristics.

The physics model can be used to predict one or more physical fields for a design (e.g., one or more design entities). The design can be, include, or represent: a physical system (e.g., physical object, chip, chipset, assembly, fluidic system, temperature field, pressure field, physical space, time, etc.), computational domain, and/or any other representation. In an example, the physical design can include a set of information (e.g., parameters, coefficients, measurements, etc.) that is associated with a physical system. However, in variants, the physical design may not be associated with a physical system (e.g., is a theoretical idea and/or conceptualization, etc.). The design can be continuous, discontinuous, and/or can have any other configuration. The design can include a single component or multiple components. The design can include geometric features of multiple length scales (e.g., subatomic-scale, atomic-scale, molecular-scale, nanometer-scale, micron-scale, meso-scale, millimeter-scale, centimeter-scale, macro-scale, meter-scale, etc.). The design can include a solid body, a shell, internal and/or external layers, perforated components, and/or have any other topology. In an example, the design can include one or more internal layers (e.g., nested shells of gold, silver, copper, or any type of internal layer). The design can include a single material or multiple materials.

The design can include: geometric information (e.g., geometric representations such meshes, point clouds, signed distance functions, geometric embeddings, geometric encodings, etc.), topological information (e.g., persistence diagram, etc.), boundary conditions (e.g., Dirichlet, Neumann, Robin, etc.), source element information, material properties and/or physical properties, and/or any other design elements. In examples, the geometric information can define the length, angles, area, curvature, distances, shape, size, scale, and/or other geometric information of the design. In examples, the topological information can define the connectivity and continuity of the shape of the design (e.g., how different parts are connected), and can preserve properties under continuous deformations (e.g., stretching, bending, twisting, etc.). In specific examples, the topology can be insensitive to length, angles, or area. However, the topological information can be otherwise defined.

The physics model can be used to predict a physical field for the physical design based on the geometric information and other design information. The physical field can represent an approximation of real-world physical phenomena across the design (e.g., design of a physical system), and can specify a spatially- and/or temporally-varying physical quantity (e.g., for the entire design, for individual spatial and/or temporal units of the design, for predefined regions of the design, etc.). The physical field can be represented as a set of numerical data (e.g., values for each voxel, values for each of a set of points, values for each time point, etc.), a visualization (e.g., contour plot, shape, animation, data plot, color-coded plot, etc.), and/or otherwise represented.

Examples of physical fields that the physics model can predict include: structural fields (e.g., stress, strain, deflection, displacement, buckling, stability, fatigue, fracture, vibration, acoustics, etc.); thermal fields (e.g., temperature distribution, heat flux, thermal stress, thermal expansion, radiative heat transfer, etc.); fluid fields (e.g., fluid dynamics, fluid flow, pressure distribution, velocity, turbulence, heat transfer, etc.); electromagnetic fields (e.g., electric field, magnetic field, electromagnetic induction, microwave analysis, RF analysis, etc.); geotechnical or porous fields (e.g., pore pressure field, saturation field, permeability field, soil displacement, etc.); quantum fields (e.g., wavefunction fields, spin fields, electron density fields, etc.); acoustic fields; chemical or biological fields (e.g., reactant/product distribution; chemical potential field, pH or ionic fields, membrane potential field, tissue growth fields, etc.); nonlinear behaviors (e.g., with stress-strain relationships); optical characteristics (e.g., refraction, complex transmission, etc.); and/or other characteristics.

The physics model is preferably a neural network or machine learning model, but can additionally or alternatively have any other architecture. In an example, the physics model can be a neural network, deep neural network, convolutional neural network (e.g., a UNet), recurrent neural network, graph neural network, transformer, a feed forward network, an encoder, a perceptron (e.g., a multilayer perceptron model (MLP)), hybrid models thereof (e.g., hybrid CNN-transformer, CNN-Swin, CNN-VIT, CRNN, transformer-RNN, etc.), ensembles thereof, and/or any other suitable network architecture. In a specific example, the physics model can have an encoder-decoder architecture or any suitable structure. The physics model can include convolutional layers, attention layers (e.g. cross attention, sliced attention, self-attention, multi-head attention, global attention, local attention, etc.), transformer blocks, recurrent layers, residual blocks, normalization layers (e.g., batch normalization, layer normalization, group normalization, instance normalization, etc.), pooling layers (e.g., max pooling, average pooling, etc.), dropout layers, dense (e.g., fully connected, linear, etc.) layers, activation functions, and/or any other components. In an example, the physics model can include a set of encoders (e.g., for the physical domain samples, the geometry, the topology, the context, etc.), a series of feed forward networks that accept the physical domain samples (PDS) embeddings, the geometric embeddings (e.g., shape embeddings), the topological embeddings, and the context embeddings as inputs, and a decoder that generates the physical field based on the resultant features. In an illustrative example, the physics model can include an optional encoder (e.g., an MLP) that encodes physical domain samples into a set of PDS embeddings, a geometry encoder, a topology encoder, a context encoder, and/or other encoders; a cross-attention layer (e.g., heterogeneous normalized cross-attention layer) or set thereof that updates the features of the physical design sample points (query points), given the geometric embedding, topology embedding, and context embeddings (e.g., boundary condition embeddings, etc.); a first feed forward network that updates the features output by the cross-attention layer; a self-attention layer (e.g., normalized cross-attention layer) or set thereof that updates the features output by the first feed forward network; a second feed forward network that updates the features output by the self-attention layer, and outputting the features (e.g., including a value for each physical domain sample) as the physical field; and/or any other suitable layers. An example of the physics model is shown in FIG. 5.

However, the physics model can have any other suitable architecture.

The physics model can receive, as input, a geometric representation of the design, a topological representation of the design, boundary conditions (e.g., Dirichlet, Neumann, Robin, etc.), source element information, material properties, a set of optional initial conditions of the physical field, a set of optional query points, and/or any other inputs.

The inputs for the physics model are preferably received at a set of input channels (e.g., at a set of input layers, at a single input layer, etc.), but can additionally or alternatively be supplied to the same attention layer (e.g., cross-attention layer), be received at intermediary layers, be independently provided to the model (e.g., at different channels, at different layer sets, etc.), and/or otherwise provided to the model. The inputs are preferably treated as the primary model inputs, but can alternatively be treated as auxiliary inputs, state inputs, conditioning inputs, and/or otherwise used. The inputs to the physics model can be at a uniform resolution or at varying resolutions (e.g., different resolutions for different regions of the design).

The physics model can generate (e.g., output, predict, infer, etc.) a physical field (e.g., physical characteristic value for each of a set of spatial and/or temporal units within the physical field; a solution to the respective governing equations; etc.), a confidence score, and/or any other output. The output of the physics model can be at a uniform resolution or at varying resolutions (e.g., different resolutions for different regions of the design).

The physics model can be trained end-to-end, in segments (e.g., separately train the encoder and decoder), and/or using any other suitable method. The physics model can be trained using supervised learning, self-supervised learning, unsupervised learning, transfer learning (e.g., from a model trained for a different physics domain, length scale, etc.), reinforcement learning, and/or otherwise learned. The physics model can be trained: once, iteratively (e.g., when a verifier provides a correct physical field), and/or at any other time. During training, the physics model can learn a set of parameters (e.g., weights, coefficients, etc.) for each layer of the model. In variants, the set of parameters can define (e.g., approximate, estimate, describe, etc.) a neural operator. The physics model can be trained on all possible inputs, a subset of inputs (e.g., using holdout method, dropout methods, etc.), or using any other method. The training data for the physics model can include: empirical data (e.g., physical measurements of physical systems), numerically solved physical fields, corrected solutions from prior physics model iterations (e.g., wherein the inferred physical field is corrected using a numerical solver), and/or any other training data (e.g., training target data).

The physics model can be trained using one or more losses. In a first example, the physics model can be trained on a single loss (e.g., data loss, physics loss, gradient loss, etc.). In a second example, the physics model can be trained on multiple weighted losses (e.g., data loss, physics loss, and gradient loss). Examples of losses that the physics model can be trained on can include data loss (e.g., ensures agreement with observational or ground-truth physical fields), physics loss (e.g., PDE residual loss; ensures the model's outputs satisfy the governing partial differential equations for the physics domain), initial condition loss (e.g., to enforce agreement with known initial states), boundary condition loss (e.g., penalizes violation of boundary constraints), gradient loss (e.g., enforces smoothness), conservation loss (e.g., penalizes deviations from conservation laws, such as mass, energy, momentum, etc.), constraint loss (e.g., enforces geometric constraints, such as non-negativity), region-specific losses (e.g., focuses the losses in certain spatial or temporal regions, such as interfaces), and/or any other losses.

In a first variant, the physics model can be trained on a data loss (e.g., L2 norm loss), wherein the determined physical field is compared against a ground-truth physical field for the design, and the physics model is updated based on the difference. The ground-truth physical field can be determined using numerical methods (e.g., numerical solvers, FEA, PDE-based solvers, etc.), experimentally determined, or otherwise determined.

In a second variant, the physics model can be trained on a physics loss, wherein the solution for the determined physical field is numerically verified (e.g., using PDEs for the respective physical characteristic), and the error can be used to update the physics model (e.g., model weights). A physics loss can include a partial differential equation residual loss, a boundary condition loss, an initial condition loss, and/or any other losses. In an example of the second variant, the solution can be passed into a partial differential equation (PDE), and the difference between the different sides of the PDE (e.g., operator side and input side, right hand and left hand sides, etc.) and/or whether PDE is solved (e.g., whether the right and left side of the PDE match) can be used as the physics loss.

In a third variant, the physics model can be trained on a gradient loss (e.g., H1 seminorm loss, H2 seminorm, etc.), wherein the gradient (e.g. derivative) of the predicted physical field is compared against the gradient of a ground truth physical field. In a fourth variant, the physics model is trained against a hybrid loss generated from the physics loss, data loss, and/or gradient loss (e.g., a weighted function of the physics loss and the data loss).

However, the physics model may be otherwise configured and/or trained.

The system can optionally include a geometric model, which functions to encode the geometry of the design into geometric embeddings (e.g., geometric latents). The geometric model can be separate from the physics model, or be part of the physics model. The geometric embeddings (e.g., geometric latents) can be used as an input into the physics model, be used as an input into an intermediate layer of the physics model (e.g., into an attention layer of the physics model), and/or otherwise used. The geometric latents can be in a geometric latent space, and/or be in any other space. The latent space(s) (e.g., geometric latent space, topological latent space, physics latent space, etc.) can be learned (e.g., by encoding the domain's values into and decoding the domain's values from the latent space, using a loss function, etc.), manually determined, transferred from another model, and/or otherwise determined. Latents can store geometric information but be non-semantic, where each value does not have a human-interpretable meaning. Alternatively, the latents can be semantic. The input of the geometric model can be a geometry of the design, a description of a design, and/or any other representation of a design. The geometry can be represented as a point cloud, a mesh (e.g., triangular mesh, quadrilateral mesh, etc.), a neural field, a signed distance function, and/or any other representation of geometry. The input of the geometric model can additionally or alternatively be a transformation and/or secondary representation of the geometry. For example, the geometry can be represented as a Fourier transform of the geometry, a wavelet transform of the geometry, a modal decomposition of the geometry, and/or any other transformation of the geometry.

The geometric model can compute numerical and/or mathematical transformations of the geometry to determine spatial encodings, positional encodings, geometric encodings, and/or any other suitable information (e.g. latents, embeddings, encodings, values, etc.). This can include determining sinusoidal positional encoding, Fourier transform coefficients, wavelet transform coefficients, rotary positional embeddings (RoPE), learned positional embeddings, relative positional embeddings, and/or any other encodings or embeddings. In examples, encodings can refer to numerical transformations of the geometric information that can be structured and/or interpretable, while embeddings (e.g. latents) can refer to learned, unstructured values that represent the geometry. Alternatively, encodings can refer to embeddings. In an illustrative example, the geometry encoding can include a representation that is globally accurate, compressed, continuous, differentiable, and capable of variable resolution, while the embedding can be a type of encoding that is learned and compact, and captures the essential characteristics of the original data. However, embeddings and encodings can be otherwise defined. In variants, the encodings can be passed through a trained encoder model to determine geometric embeddings (e.g., latents).

The geometric model is preferably an encoder (e.g., geometric encoder), but can additionally or alternatively be a transformer, a set of numerical computations and/or transformations, a tokenizer, a subset of layers from a larger model (e.g., the encoding layers from a transformer, a geometry autoencoder, a physics-informed network, etc.), a neural network (e.g., GNN, DNN, CNN, etc.), and/or any other model type.

In a first variant, the geometric model can include a transformer. The transformer can include a set of attention layers. In variants, the set of attention layers can include self-attention, cross-attention, sliced-attention, or any other type of attention layers. The transformer can include a single type of attention layer or plurality of types of layers. In a specific example of the first variant, the geometric model can use the 3Dshape2vec architecture or a modified version thereof (e.g., with CNN layers instead of FNN layers, with sliced attention layers, etc.).

In a second variant, the geometric model can include a graph neural network. For example, a GNN can be useful for encoding geometric information for meshes. However, a GNN can be used to encode any type of geometric information. In a third variant, the geometric model can include a convolutional neural network. However, the geometric model can be otherwise configured.

The system can optionally include a topological model, which functions to generate a representation of the design's topology. The topology of the geometry can explicitly describe the connections of components of the design. In variants, determining the topology of the design can be beneficial in cases in which a geometry does not capture small gaps (e.g., due to sampling, etc.). The topology can be useful for determining the flow (e.g., dissipation, propagation, diffusion, etc.) of heat, stress, mass, or any other physical quantities. The topological model can be separate from the geometric model or be part of the geometric model. The topology model can be separate from the physics model, or be part of the physics model. The topology can be used as an input into the physics model, be used as an input into an intermediate layer of the physics model (e.g., into an attention layer of the physics model), and/or otherwise used.

Inputs to the topological model can include a geometry of the design, and/or any other inputs. The input can include a point cloud, a mesh (e.g., triangular mesh, quadrilateral mesh, etc.), a neural field, a signed distance function, a scalar function of the geometry (e.g., height, curvature, density, etc.), and/or any other geometry representation. The outputs of the topological model can include a persistence diagram, Betti curves, Reeb graphs, and/or any other outputs. The persistence diagram can include birth-death coordinates and/or intervals. The persistence diagram can include persistence barcode and/or persistence landscapes.

In a first variant, the topological model can include a set of filtrations. The set of filtrations can be based on a Vietroris-Rips complex, an alpha complex, Cech complexes, witness complexes, sublevel or superlevel filtrations based on geometry properties (e.g. curvature, etc.), and/or any other basis for filtrations. The filtration process can include incrementally increasing a scale parameter to construct a sequence of nested simplicial complexes, tracking topological features as they appear and disappear through the filtrations, determining each feature's birth and death coordinates, and/or otherwise processing the filtration data.

In a second variant, the topological model can include a machine learning model. A machine learning model can be trained to predict persistence diagrams, Betti curves, Reeb graphs, topological encodings, or any suitable information based on a geometry. The topological model can include a machine learning model that can be a neural network, deep neural network, recurrent neural network, convolutional neural network, multilayer perceptron model, transformer, or any other suitable model.

However, the topological model can have any other architecture and may be otherwise configured and/or defined.

The system (and/or physics model) can include a physics encoder. The physics encoder functions to encode physics information about the design (e.g., material properties, geometric information, boundary information, source element information, initial conditions, and/or any other suitable physics information), to determine physics latents. The physics encoder is preferably part of the physics model (e.g., forms the first segment of the physics model), but can additionally or alternatively be separate from the physics model and/or otherwise related to the physics model. Additionally or alternatively the physics model can use any other model or set of layers to encode the set of physics model inputs (e.g., geometric representation, topology representation, boundary conditions, material properties, etc.) into a set of physics latents. The physics encoder can include transformer blocks, convolutional layers, downsampling layers (e.g., strided convolutions, pooling, etc.), attention mechanisms (e.g., cross attention, sliced attention, self attention, etc.), normalization layers, dense layers, pooling layers, dropout layers, and/or any other neural network components. In a first example, the physics encoder can include the set of encoding layers from a CNN or a DNN. In a second example, the physics encoder can include the set of encoding layers from a transformer. The physics encoder inputs are preferably the physics model inputs, but can additionally or alternatively include a different set of inputs.

The input of the physics encoder can include a geometric representation (e.g., geometric encodings, geometric embeddings, geometric latents, etc.), a topological representation (e.g., persistence diagram, etc.), boundary information, source element information, material properties, a set of optional initial conditions of the physical field, a set of optional query points, and/or any other inputs. In variants, the geometric representation and the topological representation can be separately generated, independently provided to the physics decoder, and/or otherwise managed. The inputs can be concurrently provided to the physics encoder, be provided at different steps of the encoding process, or any suitable method. For example, the query points may not be encoded with the other inputs. Instead, query points may be introduced to model after determining the physics latents. In another example, the inputs can be fused and/or encoded at different depths of the physics encoder-decoder model structure (e.g., early fusion of inputs, middle fusion of inputs, late fusion, etc.). In a specific variant, the geometric representation and topological representation can be encoded together (e.g., fused, etc.) to determine fused geometry latents; boundary information and source element information can be encoded together (e.g., fused, etc.) to determine constraint latents; and the geometry latents, constraint latents, and material properties can be encoded together (e.g., fused, etc.) to determine physics latents. In other variants, all inputs can be encoded together to determine physics latents. However, the encoder can encode the input into any suitable latents using any suitable method.

However, the physics encoder may be otherwise configured.

The system (and/or physics model) can include a physics decoder. The physics decoder functions to decode the physics latents to predict a physical field. The physics decoder can include an output layer, a set of transformer blocks, a set of convolutional layers, a set of upsampling layers (e.g., transposed convolutions, interpolation, etc.), a set of attention mechanisms (e.g., cross attention, sliced attention, self attention, etc.), normalization layers, activation layers, dense layers, pooling layers, dropout layers, or any suitable layers. The physics decoder is preferably part of the physics model (e.g., forms the second segment of the physics model), but can additionally or alternatively be separate from the physics model and/or otherwise related to the physics model. Additionally or alternatively, the physics model can use any other model or set of layers to decode the set of physics latents. The inputs to the physics decoder preferably includes only the physics latents, but can additionally or alternatively include the geometric representation, topological representation, the name of the physical domain(s) to be predicted (e.g., temperature, pressure, fluidics, stress, etc.), and/or any other set of inputs. The inputs to the physics decoder can be used for prediction, as conditioning variables, and/or otherwise used.

In variants, the output of the physics decoder can be a predicted physical field based on the physics latents and optionally, a set of query points. The query points can describe the spatial positions of interest for determining the predicted physical field. In a first variant, the query points can be the same as the positions used for defining the design (e.g. geometry, material properties, etc.). In a second variant, the query points can be a subset of the previously defined points. In a third variant, the query points can be different from the previously defined points. The query points can be determined in any suitable method. The physics decoder can be trained to determine any physical field (e.g., temperature, stress, strain, velocity, flow, pressure, etc.) based on the inputs.

However, the physics decoder may be otherwise configured.

The models can use classical or traditional approaches, machine learning approaches, and/or other approaches. The models can include regression (e.g., linear regression, non-linear regression, logistic regression, etc.), decision tree, LSA, clustering, association rules, dimensionality reduction (e.g., PCA, t-SNE, LDA, etc.), neural networks (e.g., CNN, DNN, CAN, LSTM, RNN, encoders, decoders, deep learning models, transformers, etc.), ensemble methods, optimization methods, classification, rules, heuristics, equations (e.g., weighted equations, etc.), selection (e.g., from a library), regularization methods (e.g., ridge regression), Bayesian methods (e.g., Naive Bayes, Markov), instance-based methods (e.g., nearest neighbor), kernel methods, support vectors (e.g., SVM, SVC, etc.), statistical methods (e.g., probability), comparison methods (e.g., matching, distance metrics, thresholds, etc.), deterministics, genetic programs, and/or any other suitable architecture. The models can include (e.g., be constructed using) a set of input layers, output layers, and hidden layers (e.g., connected in series, such as in a feed forward network; connected with a feedback loop between the output and the input, such as in a recurrent neural network; etc.; wherein the layer weights and/or connections can be learned through training); a set of connected convolution layers (e.g., in a CNN); a set of attention layers (e.g., cross-attention layers, self-attention layers, etc.); and/or have any other suitable architecture. The models can include less than 10, tens, hundreds, thousands, tens of thousands, hundreds of thousands, and/or any other number of parameters (e.g., weights, biases, etc.). The models can extract data features (e.g., feature values, feature vectors, high-dimensional features, embeddings in a high-dimensional space with hundreds or thousands of dimensions, human-unintelligible features, etc.) from the input data, and determine the output based on the extracted features. However, the models can otherwise determine the output based on the input data.

The models can be trained, learned, fit, predetermined, and/or can be otherwise determined. The models can be trained or learned using: supervised learning, unsupervised learning, self-supervised learning, semi-supervised learning (e.g., positive-unlabeled learning), reinforcement learning, transfer learning, Bayesian optimization, fitting, interpolation and/or approximation (e.g., using gaussian processes), backpropagation, and/or otherwise generated. The models can be learned or trained on: labeled data (e.g., data labeled with the target label), unlabeled data, positive training sets (e.g., a set of data with true positive labels, negative training sets (e.g., a set of data with true negative labels), and/or any other suitable set of data.

Any model can optionally be validated, verified, reinforced, calibrated, or otherwise updated based on newly received, up-to-date measurements; past measurements recorded during the operating session; historic measurements recorded during past operating sessions; or be updated based on any other suitable data.

Any model can optionally be run or updated: once; at a predetermined frequency; every time the method is performed; every time an unanticipated measurement value is received; or at any other suitable frequency. Any model can optionally be run or updated: in response to determination of an actual result differing from an expected result; or at any other suitable frequency. Any model can optionally be run or updated concurrently with one or more other models, serially, at varying frequencies, or at any other suitable time.

### 4. Method

As shown in FIG. 1, the method can include: determining a design S100; generating a geometric representation of the design using a geometric model S200; optionally generating a topological representation of the design S300; determining a context value set S400; determining a physical field S500; optionally verifying the determined physical field S600; optionally generating a corrected physical field S700; and optionally training a set of models S800. The method functions to determine (e.g., infer, predict, compute, estimate, etc.) physicals fields for a design.

The method can be used to solve one or more physics-based governing equations such as heat equations, Fick's laws, Wave equations, Maxwell's equations, Navier-Stokes equations, Schrodinger equation, elasticity equations, reaction-diffusion equations, and/or any other physics-based governing equations. The method can be used to predict structural characteristics (e.g., stress, strain, deflection, displacement, buckling, stability, fatigue, fracture, vibration, acoustics, etc.); thermal characteristics (e.g., temperature distribution, heat flux, thermal stress, thermal expansion, etc.); fluid characteristics (e.g., fluid dynamics, fluid flow, pressure distribution, velocity, turbulence, heat transfer, etc.); electromagnetic characteristics (e.g., electric field, magnetic field, electromagnetic induction, microwave analysis, RF analysis, etc.); nonlinear behaviors (e.g., with complex stress-strain relationships); optical characteristics (e.g., refraction, transmission, etc.); and/or other characteristics for a design.

The predicted physical field can be in the same space or difference space as the design. In an example, the 3D design includes a CAD file or mesh, while the predicted physical field is in a voxelized space.

In variants, the physical field can include a set of values describing a physical field in space, where the design includes the geometry, boundary conditions, source elements, material properties, and other relevant information used to determine the physical field.

In variants, the method can be used to determine steady state and/or equilibrium physical fields. However, in variants the method can be used to determine non-equilibrium and/or transient physical fields.

The physical field can be represented as a set of numerical data (e.g., values for each voxel, values for each of a set of points, etc.), a visualization (e.g., contour plot, shape, animation, data plot, color-coded plot, etc.), and/or otherwise represented. The physical fields can be predicted using geometric information (e.g., geometric representations such meshes, point clouds, signed distance functions, etc., geometric embeddings, geometric encodings, etc.), topological information, boundary conditions (e.g., Dirichlet, Neumann, Robin, etc.), source element information, material properties and/or physical properties, and/or any other relevant information. The method can be performed when a physical design is determined (e.g., received from a user, etc.), when a physical field of interest is determined (e.g., received from a user, etc.), and/or at any other suitable time. The method can be performed using a computing system, processor, graphics processing unit (GPU), cloud computing platform, supercomputer, and/or any other computing resource.

Determining a design S100 functions to determine a computational domain for analysis. A design can include a single design entity or multiple design entities. A design entity can be a continuous solid of the same material, a continuous solid of heterogeneous materials, and/or be otherwise defined.

The design is preferably a 3D solid or set of 3D solids, but can alternatively be a 3D shell, 2D element, a point cloud, a mesh, a voxel grid, a CAD design, and/or have any other suitable set of dimensionalities.

The design can be: received from a user, retrieved from a repository (e.g., the internet), automatically generated, generated by a prior iteration of the method, estimated using a different method (e.g., a coarse estimation using a numerical solver, etc.), received through a programmatic interface (e.g., an API, etc.), and/or otherwise determined. The design can be automatically generated by: permuting a set of predetermined shapes, perturbing a set of design embeddings (e.g., geometric embeddings, topological embeddings, etc.), randomly generated, and/or otherwise generated.

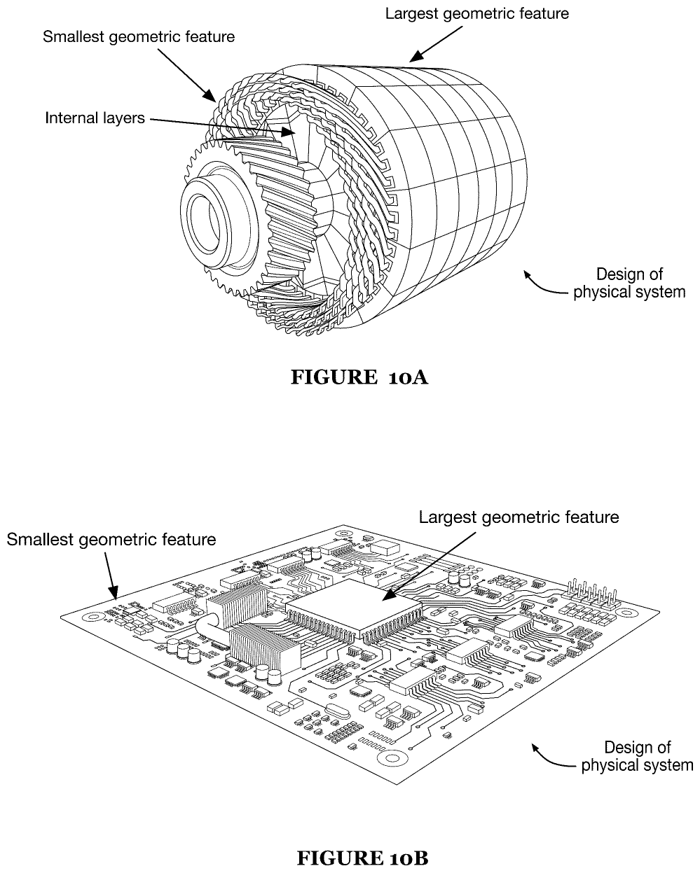

The design can be associated with aerospace, automotive, mechanical engineering, structural engineering, oil and gas, chemical processing, electronics, computer engineering, semiconductors, chip design, material design, and/or any other industry (examples shown in FIG. 10A and FIG. 10B). For example, the design can include designs for integrated circuit boards, computing systems (e.g., including boards, heatsinks, fans, etc.), industrial systems (e.g., piping networks, pressure vessels, turbines), building components (e.g., support beams, HVAC systems, etc.), consumer electronics, chemical processing systems, automotive parts (e.g., engines chassis frames), aerospace components (e.g., wing structures, fuel tanks, etc.), robotic assemblies, renewable energy systems (e.g., wind turbines, solar panels, etc.), enclosures, devices, and/or any other suitable design. The design can include a set of information (e.g., parameters, coefficients, measurement, etc.) that can be used to determine a physical field.

The design can include shapes (e.g., geometric information, topological information), materials for each part of the design, source elements (e.g., heat source, mass source, forces, charge sources, etc.), boundary conditions (e.g., Dirichlet, Neumann, Robin, etc.), initial conditions of the physical field (e.g., physical values for all or a subset of regions within the design or the physical field), and/or any other suitable set of design information.

The shapes can include geometries (e.g., solid geometry, surface geometry, curve geometry, etc.) and/or topologies (e.g., connectivity between geometric entities, orientation, etc.). The shapes and/or geometric features of the design can have at any length scale (e.g., subatomic-scale, atomic-scale, molecular-scale, nanometer-scale, micron-scale, meso-scale, millimeter-scale, centimeter-scale, macro-scale, meter-scale, etc.). A design can include shapes and/or geometric features of a single length scale or a plurality of length scales. In an example, the design can include geometric features with characteristic length scales that span between 1 and 10 magnitudes of length-scales (e.g. 1 magnitude, 2 magnitudes, 3 magnitudes, 4 magnitudes, 5 magnitudes, 6 magnitudes, 7 magnitudes, 8 magnitudes, 9 magnitudes, 10 magnitudes, or any range and/or value therebetween).

The materials for each part of the design can include material properties and/or can be represented as a set of numerical data (e.g., values for points, voxels, volumetric segments of the design, etc.). Examples of material properties that can be used can include: mechanical properties (e.g., Young's modulus, Poisson's ratio, shear modulus, bulk modulus, yield strength, ultimate tensile strength, fracture toughness, density, etc.), thermal properties (e.g., thermal conductivity, heat capacity, thermal diffusivity, coefficient of thermal expansion, melting point, etc.), electrical properties (e.g., electrical conductivity, electrical resistivity, dielectric constant and/or permittivity, breakdown voltage, piezoelectric coefficients, permeability, magnetization, etc.), fluid properties (e.g., viscosity, compressibility, surface tension, etc.), optical properties (e.g., refractive index, absorption coefficient, etc.), particulate properties (e.g., diffusion coefficient, mass diffusivity, thermal expansion coefficient, etc.), and/or any other material properties.

The source elements (e.g., heat source, mass source, forces, charge sources, etc.) can be used to describe external or internal physical influences on the design. For example, source elements can drive physical field responses in the design. Source elements can be represented as a set of numerical data (e.g., values for voxels, values for sets of points, values for geometric segments, etc.), a visualization (e.g., contour plot, shape, animation, data plot, color-coded plot, etc.), and/or otherwise represented. However, the design can be otherwise defined.

However, determining a design S100 may be otherwise performed.

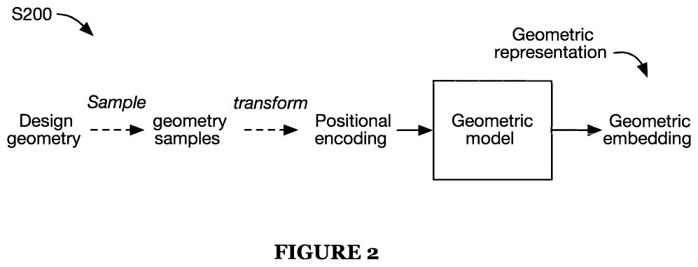

Generating a geometric representation of the design using a geometric model S200 functions to compress the geometry of the design into a format that a neural network (e.g., the physics model) can ingest. The geometric representation is preferably generated by the geometric model, but can additionally or alternatively be generated by the physics model (e.g., a set of encoding layers of the physics model) and/or otherwise generated. S200 is preferably performed once for each design, but can additionally or alternatively be performed multiple times for each design. The geometric representation is preferably of a fixed size (e.g., fixed set of matrix dimensions), but can alternatively have a variable size. The geometric representation is preferably a geometric embedding (e.g., in the geometric space, in a transformed basis), but can alternatively be a signed distance function, a point cloud, a neural field, a mesh, and/or another representation. The geometric representation preferably represents multiple design entities (e.g., the entire design), but can additionally or alternatively represent a single design entity (e.g., a component of the design, wherein S200 generates multiple geometric representations for multiple design entities of the overall design). The geometric representation preferably represents the design geometry (e.g., shape, size, surface, etc.), but can additionally or alternatively represent the design topology (e.g., physical relationship between design entities, connectivity, collisions, etc.), materials, surface properties, and/or other design parameters. An example of determining a geometric representation is shown in FIG. 2.

In variants, generating a geometric representation of the design using a geometric model S200 optionally includes converting the design geometry to a secondary representation; converting the secondary representation to a positional encoding; and/or generating the geometric representation.

Converting the design geometry to a secondary representation functions to represent the design geometry in a compact representation. In variants, converting the design geometry to the secondary representation can function to create more structured data, reduce noise, compress the data (e.g., reduce the number of coefficients to describe the geometry, etc.), or can have any other suitable function. In variants, the secondary representation can improve the performance of the geometric model by capturing underlying structure in a more compact and learnable form than point clouds or meshes.

In a first variant, the secondary representation can include a set of signed distance functions (SDF). A single SDF is preferably determined for the entire design geometry, but, alternatively, different SDFs can be determined for the geometry of each design entity. In variants, the signed distance function can be computed by first defining a spatial grid (e.g., uniform 3D lattice, non-uniform 3D lattice, etc.) that bounds the design geometry. For each grid point, a signed distance value that indicates the distance to the nearest surface of the design geometry can be computed, with the sign indicating whether the point is inside or outside the shape. This can be achieved using methods such as mesh-to-SDF conversion, analytical SDF computation for primitives, or neural implicit models. The resulting scalar field compactly encodes the geometry and can be stored as a dense voxel grid, sparse voxel tree, or continuous neural field.

In a second variant, the secondary representation can include a mesh or set thereof. In variants, the design geometry can be converted to a mesh by tessellating the boundary of the design into a set of connected polygonal faces (e.g., triangles or quadrilaterals). The mesh or set thereof can be created by first extracting the surface from volumetric data (e.g., via marching cubes from an SDF or voxel grid) or by directly using existing boundary representations from CAD or modeling software. Optionally, the mesh can be simplified, smoothed, or re-meshed to reduce noise, ensure uniform point density, or improve downstream learnability. The resulting mesh can include additional per-vertex or per-face attributes such as normals, curvature, or material labels.

In a third variant, the secondary representation can include a transformed basis of the geometry (e.g., Fourier-transformed, wavelet basis, modal decomposition, etc.).

In a fourth variant, the secondary representation can include a set of design geometry samples. The design geometry samples are preferably collected across the entire design domain (e.g., including surface samples, bulk material samples, material interface samples, etc.), but can alternatively be collected across a subset of the design domain (e.g., only the surface, only the bulk material, only material interfaces, only design entity interfaces, etc.). The design geometry can be sampled based on a set of rules, at a predetermined resolution (e.g., nanometer scale, millimeter scale, etc.), randomly, and/or otherwise sampled. Different portions of the design geometry can be sampled at the same or different resolutions. The design geometry can be sampled uniformly, non-uniformly, randomly, according to geometric feature size, and/or other suitable method. In variants, the design geometry can be sampled based on the size of geometric features of the design. For example, smaller geometric features of the design can be sampled at higher resolution than larger geometric features. In variants, the material interfaces, entity interfaces, and geometry surfaces can be preferentially sampled and a remainder of the samples can be taken from the bulk material. In another example, samples can be preferentially taken from complex regions (e.g., based on a physical geometric feature density, surface change density, etc.), but can alternatively be taken from other regions. However, the samples can be otherwise taken from the design geometry. In variants, the samples can be used as the physical domain samples (e.g., that field values are inferred for). In other variants, the samples can be used as query points for evaluating the predicted physical field (e.g., a set of spatial locations at which the physical field values are to be determined). However, the samples can be otherwise used. The samples can be determined by a sampler or another module. A predetermined number of samples can be generated; alternatively, a variable number of samples can be generated.

In a first variant, the design geometry can be sampled by converting the design geometry into a signed distance function (or set thereof) and optionally sampling the signed distance function. The signed distance function can be sampled at a specified resolution (e.g., user-specified, predetermined resolution given the design complexity, etc.) or otherwise sampled.

In a second variant, the design geometry can be sampled by voxelizing the geometry into a set of voxels. For example, the design geometry can be divided by a 3D grid into voxels. Each voxel can be assigned a density, occupancy, or other characteristic based on the design.

In a third variant, the design geometry can be sampled by converting the geometry into a point cloud. This can include sampling points of a geometry (e.g. mesh, volumetric grid, surface etc.). The points can be sampled randomly, uniformly, non-uniformly, adaptively (e.g. based on features of the geometry), or using any suitable method.

In a fourth variant, the design geometry can be represented as a neural field (e.g., as a latent vector for a set of 3D positions).

However, the design geometry can be otherwise represented (e.g., as splines, meshes, implicit surfaces, etc.).

However, converting the design geometry to a secondary representation may be otherwise performed.

Converting the secondary representation to a positional encoding functions to encode the shape in a spatial domain (e.g., without representing the spatial position explicitly for each sample). Alternatively, the method can omit converting the secondary representation into a positional encoding.

In a first variant, the positional encoding can be generated using a transform into a secondary domain. The secondary domain (e.g., space) can be a spatial domain, a spatial-frequency domain, a time-frequency domain, and/or any other suitable domain. The transformation can be a wavelet transformation, a Fourier transformation, radial basis function expansions, Legendre polynomial expansion, modal decomposition, neural basis function, and/or any other suitable transformation. In an example, the design geometry SDF can be transformed into a wavelet basis (e.g., a positional encoding representing the positions of one or more design geometry positions) using a wavelet transformation.

In a second variant, converting the secondary representation to a positional encoding can include generating the positional encoding by mapping the secondary representation to a positional embedding using a predetermined mapping.

However, converting the secondary representation to a positional encoding may be otherwise performed.

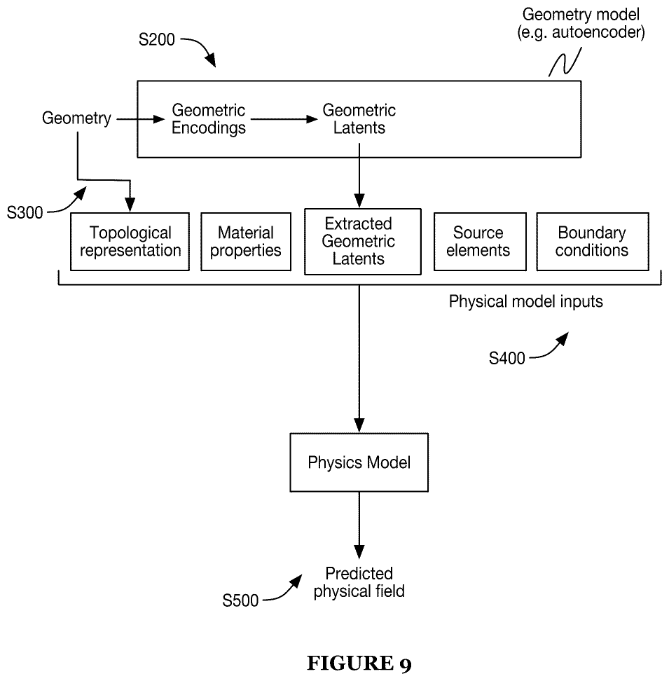

Generating the geometric representation functions to aggregate the information contained in the geometric samples into a smaller set of latent vectors. The geometric representation is preferably a set of geometric embeddings (e.g., latents) extracted from a set of intermediary neural network layers (as shown for example in FIG. 9), but can additionally or alternatively include any other geometric representation. The geometric representation is preferably generated using the geometric model (e.g., geometric encoder), but can alternatively be generated using a mapping model or any other suitable model. The geometric model is preferably a neural network, but can alternatively include a set of equations, a deterministic model, and/or have any other architecture. The geometric model is preferably an encoder, but can additionally or alternatively include the entirety of (and/or portions of) an autoencoder, a transformer, a DNN, a CNN, an RNN, a GNN, and/or have any other suitable architecture. Examples are shown in FIG. 3.

The geometric representation is preferably generated from the positional encoding (e.g., based on the occupancy value at each position, predicted from the positional encoding, etc.), but can alternatively be generated from the geometric samples, the secondary representation, and/or from any other suitable input.

The geometric model is preferably trained end to end to encode an input geometry into a latent space, then decode the latent representation back into the same geometry, but can alternatively be otherwise trained. The geometric embeddings can be extracted from an intermediary layer, wherein the encoder can include all layers up to the intermediary layer, but can alternatively be extracted from a terminal layer and/or any other suitable layer. In examples, the geometric model can include a cross-attention layer that generate a set of latents (e.g., embeddings), a KL regularization layer that receives the latents, a self-attention layer that generates a second set of latents based on the KL regularization layer output, and a set of self-attention layers that generate latent sets based on the outputs of upstream layers. The geometric embeddings can be extracted after the cross-attention layer, after one or more of the self-attention layers, and/or from any other suitable set of layers. In a second example, the geometric model can include the encoding layers from a transformer trained end-to-end (e.g., to predict a physical field, to predict the input geometry, etc.), wherein the transformer can include a set of attention layers (e.g., self attention, cross attention, sliced attention, etc.).

However, the geometric representations can be otherwise generated.

Generating a geometric representation of the design using a geometric model S200 may be otherwise performed.

The method can optionally include generating a topological representation of the design S300, which functions to represent the topology of the design. This can be useful because the geometric representation, which captures the shape of the design entities, does not necessarily capture the physical relationship between the design entities (e.g., sharp edges, creases, corners, discontinuities, etc.). In variants, the geometric representations may define continuous surfaces without clearly defining discontinuities. For example, two design entities separated by a nanometer-scale gap can appear to have the same geometry as a unitary entity without the nanometer-scale gap, but have differing topologies (e.g., gap vs. no gap). Differences in topology can be useful in physical field modeling, since the presence or absence of a gap can determine whether and how electricity, data, heat, and/or other physical phenomena are transferred through and/or around the design. In variants, the method can also function to find loops (e.g., closed loops, closed surfaces, etc.) in the design.

Additionally or alternatively, the method may omit topological representation determination in variants where the geometric representations also define discontinuities and/or collisions between component surfaces (e.g., when the geometric representation is represented as a generalized SDF, discontinuous SDF, an SDF combined with surface normal or indicator functions, disentangled representations, multi-resolution methods, meshes, point clouds with normal estimations, neural geometric representations, splines, patches, etc.).

A single topological representation representing the entire design is preferably generated; alternatively, different topological representations can be generated for different design entities, different portions of the design (e.g., interfaces vs. main body), and/or for any other design subdivision. The topology of the design can be otherwise represented. The topological representation can include embeddings in a latent space (e.g., latent topological space, different from the latent geometric space), a set of topological features, a set of positional mappings, and/or any other representation. The topological representation can include: a persistence diagram, a persistence landscape (e.g., representing the topology as a continuous function), a persistence image, topological encodings (e.g., extracting a topological signature from a persistence diagram, etc.), Betti curves (e.g., tracking the number of k-dimensional features or loops as a function of a filtration parameter), Euler characteristic curves, sheaf representations (e.g., encoding local-global consistency of data, using cohomology with coefficients, etc.), Reeb graphs, a cycle representation (e.g., extracts the explicit geometric representation of the topological feature, such as an actual loop or void), an encoder (e.g., a TDA-based deep network, TopoNet, etc.), a neural network (e.g., DNN, CNN, GNN, etc.), graph clustering, and/or otherwise determined. In a variant, the topological representation can include a list of topological features wherein each feature is characterized by a topological type (e.g., connected component, loop, void, etc.), a birth value, a death value, and/or any other characteristic.

The method can be performed by a topological model, but can alternatively be performed by the physics model (e.g., a set of embedding layers in the physics model), geometric model, and/or by any other model. The topological representation can be determined using a topological model, a transform, and/or another module.

In a first variant, the topological representation can be generated using a set of filtrations on the geometry of the design. The set of filtrations can be based on a Vietroris-Rips complex, an alpha complex, Cech complexes, witness complexes, sublevel or superlevel filtrations based on geometry properties (e.g. curvature, etc.), and/or any other filtration basis. The filtration process can include incrementally increasing a scale parameter to construct a sequence of nested simplicial complexes, tracking topological features as they appear and disappear through the filtrations, determining each feature's birth and death coordinates, and/or otherwise processing the filtration data.

In a second variant, the topological representation can be generated using a machine learning model. The machine learning model can be trained to predict persistence diagrams, Betti curves, Reeb graphs, topological encodings, or any suitable information based on a geometry. The model can be a neural network, deep neural network, recurrent neural network, convolutional neural network, multilayer perceptron model, transformer, or any other suitable model. In variants, the machine learning model can be used to determine topological latents. However, a machine learning model for determining a topological representation can otherwise function.

However, generating a topological representation of the design S300 may be otherwise performed.

Determining a context value set S400 functions to define the context that the physical field is being determined for. The context value set can include values for each of a set of contextual parameters. The context value set preferably includes all or a subset of the information required for a numerical solver formulation, but can additionally or alternatively include additional information (e.g., physical domain samples) or less information (e.g., no domain specification, etc.). The context value set can include boundary conditions (e.g., conditions imposed on the solution at the boundaries of the domain, such as Dirichlet, Neumann, Robin, mixed conditions, etc.), physical properties, an optional set of initial boundary conditions (if modeling dynamic system), an optional initial physical field (e.g., values for all or a subset of the physical field units), source elements (e.g., heat source, mass source, forces, charge sources, etc.), and/or other context parameters.

The context value set can include one or more physical properties. The physical properties can include material properties (e.g., thermal properties, mechanical properties, etc.); thermal properties (e.g., thermal conductivity, thermal diffusivity, specific heat capacity, etc.); mechanical properties (e.g., Young's modulus, shear modulus, bulk modulus, Poisson's ratio, density, etc.); electrical properties (e.g., electrical conductivity, electrical resistivity, permittivity, permeability, etc.); fluid properties (e.g., viscosity, surface tension, compressibility, etc.); optical properties (e.g., refractive index, absorption coefficient, etc.); particulate properties (e.g., diffusion coefficient, mass diffusivity, thermal expansion coefficient, etc.); and/or other coefficients for other physical properties.

The context parameters are preferably the same as the context parameters for a numerical solver in the same physical discipline (e.g., same physics domain), but can alternatively include more context parameters, less context parameters, or an entirely different set of context parameters. For example, the context parameters in the context value set for a fluid dynamics physics model can be the same as the context parameters needed to define the problem formulation for a fluid dynamics PDE set. In an illustrative example, the context parameters for a thermal model in the method can include a set of boundary conditions (e.g., conditions at the design boundaries), the highest conductivity exterior surface and an associated design position, the highest conductivity interior surface and an associated design position, optionally the lowest conductivity surface (e.g., exterior, interior, interface, etc.) and an associated design position, and/or other context parameters.

Each context value can be associated with a design position (e.g., xyz position in cartesian space, in design space, in a positional latent space as determined using a position encoder, etc.), a design domain (e.g., region or volume of the design), and/or be associated with any other suitable spatial position. The context values can each be associated with a design position (e.g., position on the geometry), but can additionally or alternatively be associated with a positional embedding, a secondary representation point, the entire design, a component of the design, and/or any other suitable subset of the design. In variants, each context value can be associated with a direction. For example, sources, boundaries, and material properties can be vectorized. This can account for anisotropic materials, directional sources (e.g., applied directional forces, mass flow, etc.), and/or any other directional elements. The context values can alternatively lack a direction.

In variants, the context value set can optionally include physical domain samples, which function to identify a set of design positions (e.g., points) for physical field inference, wherein the physical field is inferred for the set of physical domain samples (e.g., design points). Each physical domain sample preferably is not associated with physical field values, but can alternatively be associated with conditions at each of a set of design positions. The set of design positions can include or exclude the design boundaries (e.g., the boundary conditions).

The set of design positions can be located: at the bulk material of a design entity, at the material transitions or interfaces, at the design entity interfaces, and/or at any other suitable set of positions. However, the context value set can exclude the physical domain samples.

The context value set can optionally include or be associated with an analysis domain. The analysis domain is preferably dictated by the geometric representation (e.g., wherein the geometric representation represents the analysis domain), but can alternatively be otherwise represented. The analysis domain (e.g., region of the design that is analyzed) is preferably the entire design, but can alternatively be a portion of the design (e.g., manually selected, automatically selected, etc.). The analysis domain preferably includes the bulk material of the design (e.g., the design thickness, the design body, etc.), but can alternatively only include the design surface.

The context parameters within the context value set are preferably predetermined for a given physical model, but can alternatively be dynamically determined (e.g., randomly generated, permuted, determined from a prior iteration of the method, determined from an initial physical field, etc.), manually determined, retrieved from a database (e.g., of properties for a given material), and/or otherwise determined. The context value set can include values for exterior design positions, interior design positions, material transition positions, design entity interface positions, and/or any other suitable portion of the design. The context value set can be manually determined, automatically determined (e.g., looked up based on the material associated with a design entity or subregion), experimentally determined (e.g., by measuring a physical analog of the design, by measuring a physical analog of the operating context, etc.), and/or otherwise determined. The context value set can be embedded into a set of context embeddings in a latent space (e.g., using a trained encoder), encoded into a position space (e.g., by mapping the context values to positional embeddings or matrix positions representative of design positions), and/or represented using any other suitable data object. The context embedding set can include: a different embedding for each context parameter (e.g., multiple boundary condition embeddings, multiple conductivity embeddings, multiple transmissivity embeddings, etc.), a single embedding for all context parameters, and/or any other suitable set of context embeddings. However, the context value set can be otherwise determined.

However, determining a context value set S400: may be otherwise performed.

Determining a physical field S500 functions to predict (e.g., infer, estimate, approximate, compute, etc.) the physical characteristic values (physical phenomena values) at each of a set of design positions. S500 can be performed when a design is received at the system, when the model inputs are received (e.g., the geometric representation, topological representation, context value set, etc.), and/or at any other suitable time.

A physical field can describe the behavior of a physical system (e.g., defined and/or described by the 3D design) under a given context (e.g., set of conditions, the context value set, etc.). For example, the physical field in For example, the physical field can describe the temperature distribution across a part, the fluid flow characteristics within a flow chamber, the stresses and/or strains within a part, and/or other physical characteristics and/or system behaviors. In an example, the physical field determined can include a physical value (e.g., temperature value, pressure value, stress value, strain value, etc.) for each of a set of locations in a physical space (e.g., in a voxel space, in a grid space, a structured grid, an unstructured mesh, a set of nodes, for each point in a point cloud, for each location in the design, etc.). Additionally or alternatively, the physical field can be a continuous representation (e.g., represented using a spatial function, a set of basis coefficients, etc.), and/or be otherwise represented in any other manner.

The physical field can encompass only the design or encompass a region larger than the design. In the variant where the physical field encompasses a region larger than the design, the physical field can: include physical values for regions outside the design; only include physical values for regions within the design; and/or include physical values for any other region of the physical field space.

A physical field is preferably for a given physical characteristic, but can alternatively be for multiple physical characteristics. The physical characteristics that can be analyzed using this method can include structural characteristics (e.g., stress, strain, deflection, displacement, buckling, stability, fatigue, fracture, vibration, acoustics, etc.); thermal characteristics (e.g., temperature distribution, heat flux, thermal stress, thermal expansion, etc.); fluid characteristics (e.g., fluid dynamics, fluid flow, pressure distribution, velocity, turbulence, heat transfer, etc.); electromagnetic characteristics (e.g., electric field, magnetic field, electromagnetic induction, microwave analysis, RF analysis, etc.); nonlinear behaviors (e.g., with complex stress-strain relationships); optical characteristics (e.g., refraction, transmission, etc.); and/or other characteristics. The physical field can be represented as a set of numerical data (e.g., values for each voxel, values for each of a set of points, etc.), a visualization (e.g., contour plot, shape, animation, data plot, color-coded plot, etc.), and/or otherwise represented.

The physical field is preferably for a static, fully developed system (e.g., fully developed flow, steady-state temperature), but can alternatively be for a dynamic system (e.g., simulate how the physical fields change over time) or for any other suitable system. In variants that predict dynamic systems, successive physical fields for successive timesteps can be: iteratively predicted (e.g., wherein the successive iteration of the method is seeded with an initial physical field that is output by a prior iteration of the method); predicted in a single iteration (e.g., wherein the physics model outputs a set of time-varying physical field); and/or otherwise predicted.

The physical field is preferably inferred using a physics model (e.g., as discussed above; based on the context values, the geometric representation, the topological representation, etc.), but can additionally or alternatively be predicted by the physics model and/or otherwise determined by the physics model. Additionally or alternatively, the physical field can be determined by a numerical solver, a hybrid solver (e.g., mixing neural networks and numerical methods), a physics-informed neural network, and/or using any other suitable method. Each physics model in S500 can infer the physical field for a single physical characteristic (e.g., fluid dynamics, thermal distribution, etc.), or a combination of physical characteristics (e.g., perform a coupled field analysis, such as a thermo-structural analysis or fluid-structure analysis). The physics model preferably infers a value for each of a predetermined set of design points (e.g., physical domain samples, a randomly selected set of design points, a set of design points selected using a heuristic, Q, etc.), but can additionally or alternatively infer a value for each regional unit (e.g., voxel, grid, etc.) in the physical field, infer a value for a subset of regional units (e.g., wherein physical characteristic values for regional units between valued units are interpolated), and/or infer a value for any other set of regional units. The physics model preferably determines the physical field values given the geometric representation, the optional topological representation, and the context value set (and/or embeddings thereof) but can additionally or alternatively be inferred using any other suitable information. In variants, the physics model can receive a set of input embeddings (e.g., geometric embedding, topological embedding, etc.), optionally receive the keys and values for each of the embeddings, generate a set of physics embeddings from the set of input embeddings, and infer a physics field based on the set of physics embeddings.

However, determining a physical field S500: may be otherwise performed.

The method can optionally include verifying the determined physical field S600, which functions to ensure that the determined physical field is within an accuracy threshold. The accuracy threshold can be received from a user, be a predetermined or default accuracy threshold, or be otherwise determined (as shown for example in FIG. 6). The verified physical fields can be returned to the user, be used to train the physics model, and/or otherwise used.

The determined physical field can be verified by: using numerical equations for the physical characteristic (e.g., using a numerical solver for the physical characteristic or domain; verifying whether a governing equation for the physical characteristic is solved by the determined physical field; etc.), using a secondary neural network (e.g., with a different architecture, that independently computes the physical field given the same design and context value set, etc.), checking for unrealistic physical characteristic values or gradients, verifying based on the uncertainty associated with the determined physical field, and/or otherwise verifying the determined physical field.

In a first variant, the determined physical field can be verified by verifying that both sides of the PDE equations for the physical characteristic balance each other (e.g., residuals are within the accuracy threshold; differ less than a predetermined amount; etc.).

In a second variant, the determined physical field can be verified by comparing the physical field with another physical field inferred by a second physics model for the same physical characteristic (e.g., a physics-informed neural network, a numerical solver, etc.), wherein the determined physical fields are verified if they differ less than a predetermined threshold (e.g., the accuracy threshold, at a predetermined resolution, etc.).

In a third variant, the determined physical field can be verified by seeding a numerical solver with the determined physical field, and verifying the solution when the numerical solver converges within a threshold number of iterations (e.g., 1 iteration, 10 iterations, 100 iterations, etc.; less iterations than it would have taken to solve the analysis de novo using the numerical solver; etc.). The numerical solver can reach convergence when the residuals are within an accuracy threshold (e.g., 1×10⁻¹⁵, 1×10⁻¹³, etc.); when the solution changes less than a threshold amount between iterations; when a steady-state is reached; and/or upon occurrence of any other convergence condition. However, verifying the determined physical field S600 may be otherwise performed.

The method can optionally include generating a corrected physical field S700, which functions to generate a physical field that has at least the threshold accuracy. S700 is preferably performed when the determined physical field fails the verification (e.g., is outside of the threshold accuracy), but can alternatively be performed at any other suitable time. The corrected physical field can be: returned to the user, used to train the physics model (e.g., wherein the physics model is trained to infer the corrected physical field given the design and context values; used to calculate the data loss; etc.), and/or otherwise used. S700 is preferably performed using a numerical solver, but can additionally or alternatively be performed using a secondary neural network (e.g., a PINN), and/or otherwise performed.

In a first variant, generating a corrected physical field S700 can include initializing or seeding a numerical solver with the determined physical field (e.g., output by S500), wherein the numerical solver uses the determined physical field as an initial guess to calculate the final solution (e.g., to iteratively converge on a solution with at least the threshold accuracy). In examples of the first variant, numerical solvers that can be used include various types of solvers. Examples of numerical solvers that can be used include: finite difference method (FDM), finite element method (FEM), finite volume method (FVM), and/or any other suitable method.

In a second variant, the corrected physical field can be generated by solving the physical field de novo with the numerical solver, using the design and the context value set.

In variants, a numerical solver for S700 can include solve conditions, premature stop conditions, or any suitable solution mechanisms, as shown for example in FIG. 7. For example, solve conditions can include a threshold residual tolerance, relative change in solution, absolute change in solution, gradient norm, objective function tolerance, or any suitable parameter threshold. Premature stop conditions can include a threshold number of iterations, time limit, determination of oscillating behavior, solver-specific heuristics, or any other suitable condition. However, the physical field can alternatively be otherwise corrected.

However, generating a corrected physical field S700 may be otherwise performed.

In a variant, the method can include both verification S600 and correction S700. In another variant, the method can include just a verification step S600 or just correction step S700. However, in other variants, the method may not include either step.

The method can optionally include training a set of models S800, which functions to learn ML parameter values (e.g., weights, coefficients, biases, and/or any other suitable ML parameter values) for the physics model, the geometric model, the topological model, and/or other models. Each model can be trained: trained end-to-end, piecewise (e.g., the encoding layers are trained independently of the decoding layers), or otherwise trained. The models can be trained using supervised learning, unsupervised learning, semi-supervised learning, reinforcement learning, transfer learning, and/or any other training method. S800 can include training multiple models together, in parallel, independently, and/or otherwise trained. In an example wherein geometric model layers are part of the physics model, the model can be trained end to end, such that the geometric model parameters and physics encoder parameters are learned together. In an example, wherein the geometric model is separate from the physics model, each model can be trained independently.

The set of models can be trained using: a physics-based loss (e.g., loss computed using the governing partial differential equations for the physical characteristic; a loss function that penalizes violation of physics-based constraints; etc.), a data-based loss (e.g., loss computed by comparing the predicted output and a ground-truth value), gradient-based losses (e.g., gradient difference loss, gradient norm loss, Jacobian loss, seminorm losses, etc.), regression losses (e.g., MSE, MAE, Huber loss, quantile loss, etc.), classification losses (e.g., binary classification, multiclass classification, etc.), ranking losses (e.g., contrastive loss, triplet loss, etc.), divergence losses, autoencoder losses, normal consistency, Laplacian loss, cross-entropy losses, and/or any other losses. However, the set of models can be otherwise trained.

In variants, training a set of models S800 includes training the geometric model; training the physics model; and optionally training the topological model.

Training the geometric model functions to learn parameters for the geometric model that encode a geometric representation. In variants in which the geometric model can be an autoencoder, the geometric model can be trained end to end such that the model accurately reconstructs the input geometry (e.g., in the same or different space as the input geometry). The training dataset can include a set of geometries, wherein the training target is the same set of geometries (e.g., unsupervised learning). Training the geometric model can include determining a loss, wherein the loss is a difference between the input geometry and the predicted output geometry. The loss function can incorporate multiple terms, such as reconstruction loss, regularization terms (e.g., smoothness, sparsity), adversarial loss for improved realism, and/or any other loss. The geometric model's performance can be evaluated using quantitative metrics such as Chamfer distance, Earth Mover's Distance (EMD), or Intersection over Union (IoU) between input and reconstructed geometries. Gradient descent can be performed based on the computed loss to update the model parameters. Alternatively, optimization methods such as the Newton-Raphson method, stochastic gradient descent (SGD), Adam, RMSProp, Adagrad, or other advanced gradient-based algorithms can be used. The geometric model can be otherwise trained.

However, training the geometric model may be otherwise performed.

Training the physics model functions to learn parameters for the physics model to accurately predict a physical field.

In a first variant, the geometric model is separate from the physics model. In variants where the geometric model is separate from the physics model, geometric latents can be extracted from the geometric model (e.g., from the outputs of the geometric model's encoding layers). The physics model can be trained to predict a physical field based on the geometric latents, the context value set, optionally the topological representation, and/or other inputs. The training data inputs can include geometric latents, a topological representation, the context value set (e.g., boundaries, source elements, material properties), and/or any other information. The training target can be a physical field (e.g., measured, received from a user, predicted using a numerical solver, etc.) and/or be any other set of training targets. In a second variant, the geometric model can be integrated into the physics model. In variants, the physics model can include geometric encoding layers (e.g., layers that encode input geometry information, etc.) and physics encoding layers (e.g., layers that encode the context value set with the geometric representation, etc.), in which all parameters for both encoding layer sets are learned together during training. The training data set can include a geometric representation (e.g. point cloud, mesh, signed distance function, etc.), a topological representation, the context value set (e.g., boundaries, source elements, material properties), and/or any other suitable information.

Training the physics model can include determining a physics loss, a data loss, a gradient loss, a hybrid loss, and/or other types of losses.

The physics loss can include a partial differential equation residual loss, a boundary condition loss, an initial condition loss, and/or any other type of physics loss. The physics loss can include a residual and/or difference computed when the predicted physical field is plugged into a physics-based equation or physical constraint.

The data loss measures the discrepancy between the predicted physical field and a ground-truth physical field. The training target can be a ground truth physical field. In variants, the ground truth can be measured, experimentally determined, or otherwise determined. The ground truth physical field can be determined using numerical methods, an iterative solver, a numerical solver, or using any other suitable method. The ground truth physical field can be determined based on the same design, the same context value set, and/or other shared inputs. Alternatively, the ground truth physical field can be determined using different inputs. Examples of data losses that can be used include: mean squared error (e.g., L2 norm) between the predicted field and a ground-truth field, mean absolute error (e.g., L1 loss), Huber loss, and/or any other type of data loss.

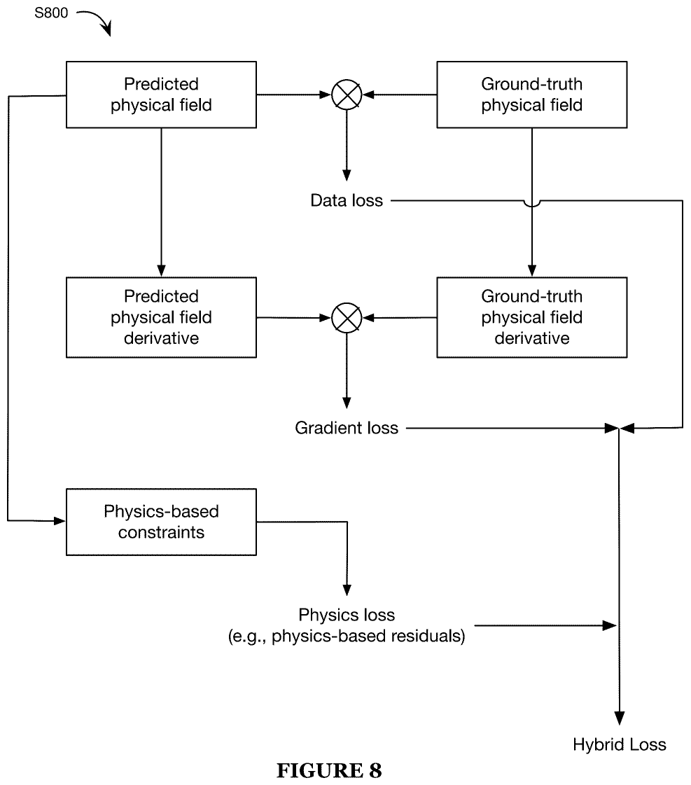

The gradient loss penalizes differences between gradients of the predicted field and the ground-truth field (e.g., L1 seminorm, etc.). The gradient loss encourages accurate prediction of the physical field's local variations and smoothness properties. In variants, H1 norm, which includes the residuals of the values and the residuals of the derivatives, can be used. The hybrid loss combines two or more of the above losses (e.g., physics loss+data loss+gradient loss) into a single objective, as shown for example in FIG. 8.

The hybrid loss can be a weighted sum of other losses, an average of the losses, and/or otherwise constructed. This allows the model to leverage both physical laws and data-driven information simultaneously, balancing them via weighting factors. Hybrid losses can improve training stability and solution accuracy when pure physics or pure data losses alone are insufficient. A hybrid loss function can include weights for each type of loss. The weights can be manually determined, learned, tuned, determined based on the input resolution, determined based on a physical property of the physical design (e.g., mass, volume, etc.), or determined in any suitable method.

The physics model parameters (e.g., weights, biases, etc.) can be updated based on the computed losses (e.g., using backpropagation, etc.). In an example, gradient descent can be performed based on the computed loss to update the model parameters. Alternatively, optimization methods such as the Newton-Raphson method, stochastic gradient descent (SGD), Adam, RMSProp, Adagrad, or other advanced gradient-based algorithms can be used.

However, training the physics model may be otherwise performed.

The method can optionally include training the topological model, which functions to learn parameters for a topological model to accurately predict a topological representation of a design. In variants in which the topology module includes a machine learning model, the topology machine learning model can be trained to predict persistence diagrams (e.g. persistence barcodes, persistence landscapes, a list of birth-death coordinates) or topological latents from the geometry of a design (e.g., point cloud, mesh, signed distance function, etc.). The training dataset can include a set of geometries, wherein the training target includes the corresponding persistence diagrams. The training target persistence diagrams can be determined using filtration methods and/or otherwise determined. Training the topological model can include determining a loss, wherein the loss is a difference between the predicted persistence diagram and the persistence diagram determined from traditional methods (e.g. filtration, etc.), or otherwise training the topological model. Gradient descent can be performed based on the computed loss to update the model parameters. Alternatively, optimization methods such as the Newton-Raphson method, stochastic gradient descent (SGD), Adam, RMSProp, Adagrad, or other advanced gradient-based algorithms can be used. However, training the topological model may be otherwise performed.

However, training a set of models S800 may be otherwise performed.

### 5. Specific Examples

Specific Example 1. A method comprising: determining a physical design of a physical system; determining a geometric representation of a geometry of the physical design; determining a set of geometric embeddings based on the geometric representation; determining a topological representation of the geometry of the physical design; providing the topological representation, geometric embeddings, and a set of boundary conditions as inputs to a machine learning model; and predicting a physical field for the physical system using the machine learning model.

Specific Example 2. The method of Specific Example 1, wherein the topological representation comprises a persistence diagram.

Specific Example 3. The method of Specific Example 1, wherein the set of geometric embeddings comprises a set of geometric latents, wherein the set of geometric latents are determined by embedding the geometric representation into a geometric latent space using a transformer.

Specific Example 4. The method of Specific Example 1, wherein the physical design comprises a set of physical internal layers, wherein the geometric representation, the topological representation, and the physical field comprise values for each of the set of physical internal layers.

Specific Example 5. The method of Specific Example 1, wherein determining the geometric representation comprises: determining a signed distance function for the geometry of the physical design using a set of winding numbers; and determining a wavelet transform of the signed distance function.

Specific Example 6. The method of Specific Example 1, wherein the inputs further comprise: material property information and source element information.

Specific Example 7. The method of Specific Example 1, wherein the inputs are ingested together by a set of input channels of an initial input layer of the machine learning model when predicting a physical field.

Specific Example 8. The method of Specific Example 1, wherein the predicted physical field is refined into a final solution using an iterative numerical solver.

Specific Example 9. The method of Specific Example 1, wherein the machine learning model is trained using a hybrid loss comprising a physics-based loss, a data loss, and a gradient loss, wherein the hybrid loss comprises different weights for the physics-based loss, the data loss, and the gradient loss.

Specific Example 10. The method of Specific Example 1, wherein the geometry of the physical design comprises a set of geometric features, wherein a characteristic length-scale of a smallest geometric feature of the set differs from a characteristic length-scale of a largest geometric feature of the set by at least four orders of magnitude.

Specific Example 11. A method comprising: determining a physical design of a physical system; determining a set of geometric latents for a geometry of the physical design using a geometric encoder; determining a set of explicit physical parameters for the physical design; predicting a physical field using a machine learning model based on the set of explicit physical parameters and the geometric latents; seeding a numerical solver with the predicted physical field; and determining a final solution for the physical system using the numerical solver seeded with the predicted physical field.

Specific Example 12. The method of Specific Example 11, wherein the geometric encoder is a subnetwork of a trained autoencoder.

Specific Example 13. The method of Specific Example 11, wherein the determining a final solution using the numerical solver comprises halting the numerical solver when a predetermined stop condition is satisfied, prior to determining a solution that is converged.

Specific Example 14. The method of Specific Example 13, wherein the predetermined stop condition comprises a maximum number of numerical solver iterations.

Specific Example 15. The method of Specific Example 11, wherein the set of explicit physical parameters comprises a topological representation of the physical design, a set of boundary conditions, and a set of material properties for the physical design.

Specific Example 16. The method of Specific Example 11, wherein the set of geometric latents are determined by embedding a geometry of the physical design using a set of sliced attention layers.

Specific Example 17. The method of Specific Example 11, wherein the machine learning model is retrained using the final solution.

Specific Example 18. The method of Specific Example 11, wherein the machine learning model is trained on a set of training data, wherein training the machine learning model comprises determining a physics-based loss and a data loss.

Specific Example 19. The method of Specific Example 18, wherein the machine learning model is further trained on a gradient loss, wherein the gradient loss comprises a difference between a gradient of a physical field prediction and a gradient of a ground-truth physical field.

Specific Example 20. The method of Specific Example 18, wherein determining the physics-based loss comprises evaluating whether a physical field prediction satisfies a set of governing physics equations for the physical system.

All references cited herein are incorporated by reference in their entirety, except to the extent that the incorporated material is inconsistent with the express disclosure herein, in which case the language in this disclosure controls.

As used herein, “substantially” or other words of approximation can be within a predetermined error threshold or tolerance of a metric, component, or other reference, and/or be otherwise interpreted.

Optional elements, which can be included in some variants but not others, are indicated in broken line in the figures.

Different subsystems and/or modules discussed above can be operated and controlled by the same or different entities. In the latter variants, different subsystems can communicate via: APIs (e.g., using API requests and responses, API keys, etc.), requests, and/or other communication channels. Communications between systems can be encrypted (e.g., using symmetric or asymmetric keys), signed, and/or otherwise authenticated or authorized.

Alternative embodiments implement the above methods and/or processing modules in non-transitory computer-readable media, storing computer-readable instructions that, when executed by a processing system, cause the processing system to perform the method(s) discussed herein. The instructions can be executed by computer-executable components integrated with the computer-readable medium and/or processing system. The computer-readable medium may include any suitable computer readable media such as RAMs, ROMs, flash memory, EEPROMs, optical devices (CD or DVD), hard drives, floppy drives, non-transitory computer readable media, or any suitable device. The computer-executable component can include a computing system and/or processing system (e.g., including one or more collocated or distributed, remote or local processors) connected to the non-transitory computer-readable medium, such as CPUs, GPUs, TPUS, microprocessors, or ASICs, but the instructions can alternatively or additionally be executed by any suitable dedicated hardware device.

Embodiments of the system and/or method can include every combination and permutation of the various system components and the various method processes, wherein one or more instances of the method and/or processes described herein can be performed asynchronously (e.g., sequentially), contemporaneously (e.g., concurrently, in parallel, etc.), or in any other suitable order by and/or using one or more instances of the systems, elements, and/or entities described herein. Components and/or processes of the following system and/or method can be used with, in addition to, in lieu of, or otherwise integrated with all or a portion of the systems and/or methods disclosed in the applications mentioned above, each of which are incorporated in their entirety by this reference.

As a person skilled in the art will recognize from the previous detailed description and from the figures and claims, modifications and changes can be made to the preferred embodiments of the invention without departing from the scope of this invention defined in the following claims.

We claim:

1. A method comprising:
determining a physical design of a physical system;
determining a geometric representation of a geometry of the physical design;
determining a set of geometric embeddings based on the geometric representation;
determining a topological representation of the geometry of the physical design;
providing the topological representation, geometric embeddings, and a set of boundary conditions as inputs to a machine learning model; and
predicting a physical field for the physical system using the machine learning model.

2. The method of claim 1, wherein the topological representation comprises a persistence diagram.

3. The method of claim 1, wherein the set of geometric embeddings comprises a set of geometric latents, wherein the set of geometric latents are determined by embedding the geometric representation into a geometric latent space using a transformer.

4. The method of claim 1, wherein the physical design comprises a set of physical internal layers, wherein the geometric representation, the topological representation, and the physical field comprise values for each of the set of physical internal layers.

5. The method of claim 1, wherein determining the geometric representation comprises:
determining a signed distance function for the geometry of the physical design using a set of winding numbers; and
determining a wavelet transform of the signed distance function.

6. The method of claim 1, wherein the inputs further comprise: material property information and source element information.

7. The method of claim 1, wherein the inputs are ingested together by a set of input channels of an initial input layer of the machine learning model when predicting a physical field.

8. The method of claim 1, wherein the predicted physical field is refined into a final solution using an iterative numerical solver.

9. The method of claim 1, wherein the machine learning model is trained using a hybrid loss comprising a physics-based loss, a data loss, and a gradient loss, wherein the hybrid loss comprises different weights for the physics-based loss, the data loss, and the gradient loss.

10. The method of claim 1, wherein the geometry of the physical design comprises a set of geometric features, wherein a characteristic length-scale of a smallest geometric feature of the set differs from a characteristic length-scale of a largest geometric feature of the set by at least four orders of magnitude.

11. A method comprising:
determining a physical design of a physical system;
determining a set of geometric latents for a geometry of the physical design using a geometric encoder;
determining a set of explicit physical parameters for the physical design;
predicting a physical field using a machine learning model based on the set of explicit physical parameters and the geometric latents;
seeding a numerical solver with the predicted physical field; and
determining a final solution for the physical system using the numerical solver seeded with the predicted physical field.

12. The method of claim 11, wherein the geometric encoder is a subnetwork of a trained autoencoder.

13. The method of claim 11, wherein the determining a final solution using the numerical solver comprises halting the numerical solver when a predetermined stop condition is satisfied, prior to determining a solution that is converged.

14. The method of claim 13, wherein the predetermined stop condition comprises a maximum number of numerical solver iterations.

15. The method of claim 11, wherein the set of explicit physical parameters comprises a topological representation of the physical design, a set of boundary conditions, and a set of material properties for the physical design.

16. The method of claim 11, wherein the set of geometric latents are determined by embedding a geometry of the physical design using a set of sliced attention layers.

17. The method of claim 11, wherein the machine learning model is retrained using the final solution.

18. The method of claim 11, wherein the machine learning model is trained on a set of training data, wherein training the machine learning model comprises determining a physics-based loss and a data loss.

19. The method of claim 18, wherein the machine learning model is further trained on a gradient loss, wherein the gradient loss comprises a difference between a gradient of a physical field prediction and a gradient of a ground-truth physical field.

20. The method of claim 18, wherein determining the physics-based loss comprises evaluating whether a physical field prediction satisfies a set of governing physics equations for the physical system.
